(19) United States
(12) Patent Application Publication
(10) Pub. No.: US 2007/0270158 A1
(43) Pub. Date: Nov. 22, 2007

(54) GENERATING LOCATION BASED AND MULTIMEDIA SERVICES IN A DIGITAL WIRELESS NETWORK

(76) Inventors: Qi Bi, Morris Plain, NJ (US); Xin Wang, Parsippany, NJ (US); Yang Yang, Parsippany, NJ (US); Lily H. Zhu, Morris Plain, NJ (US)

Correspondence Address: WILLIAMS, MORGAN & AMERSON, 10333 RICHMOND, SUITE 1100, HOUSTON, TX, 77042, US

(21) Appl. No.: 11/419,294

(22) Filed: May 19, 2006

(51) Int. Cl. H04Q 7/20

(52) U.S. Cl. 455/456.1

(57) ABSTRACT

The present invention provides a method and an apparatus for enabling at least one location-based service between an originating party and a destination party on a wireless network. The method comprises integrating access to the at least one location-based service substantially simultaneously with an offering of at least one multi-media service for voice and data over the wireless network. The method further comprises initiating the at least one location-based service in response to receiving an inquiry from the originating party for determining a network location of a target mobile terminal associated with the destination party. A service platform may generate substantially simultaneously multi-media services including a location-based service based on location information of a destination user in a wireless network, such as a mobile data network.

### 1. FIELD OF THE INVENTION

This invention relates generally to telecommunications, and more particularly, to wireless communications.

### 2. DESCRIPTION OF THE RELATED ART

Wireless communications systems or mobile telecommunication systems typically provide different types of services to different users or subscribers of wireless communication devices. The wireless communication devices may be mobile or fixed units and situated within a geographic region across one or more wireless networks. The users or subscribers of wireless units or communication devices, such as mobile stations (MSs) or access terminals or user equipment may constantly move within (and outside) particular wireless networks.

A wireless communications system generally includes one or more base stations (BSs) that can establish wireless communications links with wireless units. Each wireless unit has an active set, which comprises a set of base stations with which it may communicate. Base stations may also be referred to as node-Bs or access networks. To form the wireless communications link between a wireless unit and a base station, the wireless unit accesses a list of available channels (or carriers) broadcast by the base station.

Wireless services, such as multi-media services, especially content-intensive media services are becoming popular among technology savvy consumers. Despite advances in computing and networking, transporting network traffic generally depends upon real-time network performance for many content-intensive media services. Typically, a data network is deployed to transport network traffic associated with a variety of multi-media services, such as voice and data services involving interaction from users. However, an increasing number of multi-media services, and other services, impose user demands on the data network usage for transportation of service traffic. These user demands, such as quality-of-service (QoS) requirements, may be expressed in terms of throughput and end-to-end delay.

In particular, wireless mobile networks have been evolving into packet data transmission paradigm. For example, a high rate packet data (HRPD) Rev. A system incorporates various features of 1× Evolution—Data Only (1×EV-DV) and improves reverse link performance. Other access systems include Universal Mobile Telecommunication System (UMTS) High Speed Packet Access (HSPA) system. UMTS is one of the third generation (3^{rd} G) standards that is based on Wideband Code Division Multiple Access (W-CDMA). UMTS may enable an internet connection of at least 384 kbps and up to about 2 mbps. High Speed Packet Access (HSPA) is a UMTS Radio Interface in the Releases 5 and 6 of the 3rd Generation Partnership Project (3GPP) standards. HSPA provides improvements in the UMTS downlink, often referred to as High Speed Downlink Packet Access (HSDPA), and in the uplink, often referred to as High Speed Uplink Packet Access (HSUPA), or in the Enhanced Dedicated Channel (E-DCH). HSDPA enables data transmission speeds of up to 14.4 Mbit/s per user in the standard 5 MHz carrier of UMTS networks.

Another access system often referred to as Worldwide Interoperability for Microwave Access (WiMax) system may also provide high-speed wireless data services with desired QoS capability. The WiMax access system is based on the Institute of Electrical and Electronics Engineers (IEEE) 802.16 standard, which ensures compatibility and interoperability between broadband wireless access equipment in broadband wireless networks that provide point-to-multipoint broadband wireless access.

Wireless or mobile data service providers desire applications that can take advantage of the advanced mobile data network features and provide multi-media services to users. Many HRPD service providers lack such applications, thus limiting full utilization of the radio frequency (RF) resources and widespread deployment of multi-media services to users. Another reason for a relatively slow penetration of wireless or mobile data services is the wide availability of wireline and fixed wireless data systems, such as Digital Subscriber Loop (DSL), Cable Modem, Fiber-To-The-Home, and Wireless Fidelity (Wi-Fi) standard for wireless local area networks (WLAN) based on the IEEE 802.11 specifications, that provide many choices of data access from home, office or hotels in most of the areas.

The cellular network operators or mobile data network service providers attract mass subscribers or large amounts of traffic in cellular networks from mainstream wireless services for voice and data, but find it difficult to combine service offering with multi-media services. For example, as compared to mobile data networks, which are generally built on top of a traditional cellular network, the wireline and fixed wireless data systems access systems often provide more cost effective service access with even higher access bandwidth to multi-media services including location-based services. A location-based service refers to a multi-media service offering based on a subscriber's self location and/or tracking of a remote user's location. Both of these location-based services target different markets, with very specific functional support, and may attract different subscribers or larger amounts of traffic than the mainstream wireless services in the cellular networks. As a result, cellular network operators or mobile data network service providers might fail to competitively provide service access to attract service consumers or fail to efficiently provide access bandwidth desired for multi-media services including location-based services along with the mainstream wireless services.

### SUMMARY OF THE INVENTION

The following presents a simplified summary of the invention in order to provide a basic understanding of some aspects of the invention. This summary is not an exhaustive overview of the invention. It is not intended to identify key or critical elements of the invention or to delineate the scope of the invention. Its sole purpose is to present some concepts in a simplified form as a prelude to the more detailed description that is discussed later.

The present invention is directed to overcoming, or at least reducing, the effects of, one or more of the problems set forth above.

In one illustrative embodiment of the present invention, a method is provided for enabling at least one location-based service between an originating party and a destination party on a wireless network. The method comprises integrating access to the at least one location-based service substantially simultaneously with an offering of at least one multi-media service for voice and data over the wireless network. The method further comprises initiating the at least one location-based service in response to receiving an inquiry from the originating party for determining a network location of a target mobile terminal associated with the destination party.

In another illustrative embodiment of the present invention, a method is provided for enabling at least one location-based service between an originating party and a destination party on a wireless network. The method comprises receiving an indication of an inquiry at a target mobile terminal for determining a remote location of the destination party for the at least one location-based service. The method further comprises providing location information of the target mobile terminal to the originating party over the wireless network in response to the indication.

In yet another illustrative embodiment of the present invention, a method is provided for enabling at least one location-based service between an originating party and a destination party on a wireless network. The method comprises sending an inquiry for a remote location of a user of a target mobile terminal available to the destination party to initiate the at least one location-based service for the destination party over the wireless network.

### BRIEF DESCRIPTION OF THE DRAWINGS

The invention may be understood by reference to the following description taken in conjunction with the accompanying drawings, in which like reference numerals identify like elements, and in which:

FIG. 1 schematically depicts a high-speed wireless communication system for generating a location-based service and at least one multi-media service by a wireless service provider at a tracking mobile terminal of an originating party in a digital wireless network according to one illustrative embodiment of the present invention;

FIG. 2 illustrates a stylized representation of a service platform that enables substantially simultaneously the location-based service and the multi-media service using messages between the digital wireless network shown in FIG. 1 and the tracking mobile terminal, a target mobile terminal of a destination party in response to a location inquiry initiated by the originating party according to one illustrative embodiment of the present invention; and

FIG. 3 depicts a stylized representation for implementing a method of enabling the location-based service between the originating party and the destination party shown in FIG. 1 consistent with one exemplary embodiment of the present invention.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION OF SPECIFIC EMBODIMENTS

Illustrative embodiments of the invention are described below. In the interest of clarity, not all features of an actual implementation are described in this specification. It will of course be appreciated that in the development of any such actual embodiment, numerous implementation-specific decisions may be made to achieve the developers' specific goals, such as compliance with system-related and business-related constraints, which will vary from one implementation to another. Moreover, it should be appreciated that such a development effort might be complex and time-consuming, but may nevertheless be a routine undertaking for those of ordinary skill in the art having the benefit of this disclosure.

Generally, a service platform is provided for generating substantially simultaneously multi-media services including a location-based service based on location information of a destination user in a wireless network, such as a mobile data network. Unlike other location-tracking services in which a network proactively tracks a target mobile terminal and notifies the tracking entity whenever the location changes, a location inquiry may be initiated by an originating party. By exchanging messages between the wireless network and mobile terminals of both the originating party and a destination or terminating party, the service platform enables the location-based service. The same service platform may support the multi-media services simultaneously with the location-based service rather than triggering the location-based services by location information in a uni-directional service interaction and enabling only either the multi-media or location-based services at a time. Instead, in a high-speed wireless communication system, for example, the service platform may generate a location-based service and at least one multi-media service by a wireless service provider at a tracking mobile terminal of an originating party in a digital wireless network. Such an integrated service generating platform triggered by on-demand location inquiries may boost traffic usage on a mobile data network for mobile data network service providers.

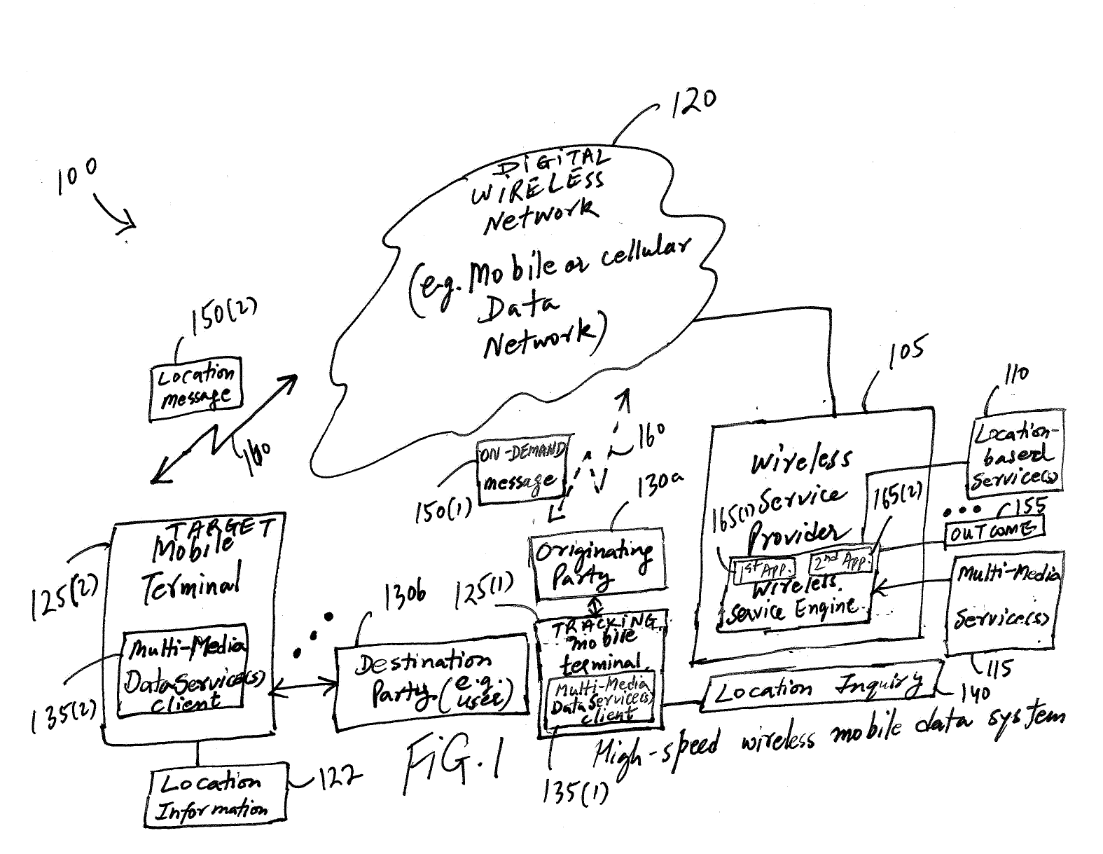

Referring to FIG. 1, a high-speed wireless communication system 100 is illustrated to include a wireless service provider 105 that may provide substantially simultaneously a location-based service(s) 110 and a multi-media service(s) 115 on a wireless network, such as a digital wireless network 120 according to one illustrative embodiment of the present invention. While the location-based service(s) 110 may be a service based on location information 122 of a destination user in the digital wireless network 120, the multi-media service(s) 115 may be a service for delivering voice and/or data. Examples of the location-based service(s) 110 include a network location of the target mobile terminal 125(2), a map of a neighborhood, point of attractions around a remote or geo location of a user and the examples of the multi-media service(s) 115 include digital media and entertainment services.

In the high-speed wireless communication system 100, a tracking mobile terminal 125(1) associated with an originating party 130a and a target mobile terminal 125(2) associated with a destination party 130b may wirelessly communicate with the wireless service provider 105 over the digital wireless network 120. To support the multi-media service(s) 115 simultaneously with the location-based service(s) 110, the tracking mobile terminal 125(1) may comprise a multi-media data service client 135(1). Likewise, the target mobile terminal 125(2) may comprise a multi-media data service client 135(2). For providing the location-based service(s) 110 to the originating party 130a, the multi-media data service client 135(1) may initiate a location inquiry 140 of the destination party 130b. The multi-media data service client 135(2) may provide the location information 122 of the destination party 130b, such as a destination user within the digital wireless network 120.

The wireless service provider 105 may comprise a wireless service engine 145 to enable an integrated and simultaneous access to the multi-media service(s) 115 and the location-based service(s) 110. The wireless service engine 145 may exchange messages with the media data service clients 135(1, 2) over the digital wireless network 120. By using the messages between the digital wireless network 120 and the tracking mobile terminal 125(1), the target mobile terminal 125(2), the wireless service provider 105 may enable the location-based service(s) 110 in response to the location inquiry 140.

For example, using the media data service client 135(1), the originating party 130a may send the location inquiry 140 to the wireless service provider 105 in an on-demand message 150(1) from the tracking mobile terminal 125(1). In response to the location inquiry 140, the wireless service engine 145 at the wireless service provider 105 may communicate with the target mobile terminal 125(2) over the digital wireless network 120. By using the media data service client 135(2), the target mobile terminal 125(2) may return the location information 122 in a message that may be used to derive the location thereof. A location message 150(2) from the target mobile terminal 125(2) may comprise the location information 122, which the wireless service provider 105, in turn, provides to the tracking mobile terminal 125(1) in an outcome 155 from the wireless service engine 145. The wireless service engine 145 may generate the outcome 155 for the location inquiry 140 to trigger at least one location-based service 110 on-demand by the originating party 130a.

The wireless service engine 145 may further enable an integrated data access to a set of digital wireless services associated with the location-based service(s) 110 for a subscriber over the digital wireless network 120. The wireless service engine 145 may determine a remote location of a user based on a network location of the target mobile terminal 125(2) available to the destination party 130b on the digital wireless network 120. By using an indication of user mobility of the user over the digital wireless network 120 and a capability to retrieve the location information 122 of the target mobile terminal 125(2), the wireless service provider 105 may offer the location-based service(s) 110.

Consistent with one embodiment, the tracking and target mobile terminals 125(1, 2) may transmit messages to the digital wireless network 120 over a reverse link. In the high-speed wireless communication system 100, a wireless communication between the digital wireless network 120 and the tracking and target mobile terminals 125(1, 2) may occur over an air interface 160 via a radio frequency (RF) medium that may use a code division multiple access (CDMA) protocol to support multiple users. A forward link may provide messages to the tracking and target mobile terminals 125(1, 2). The messages may include traffic packets and signaling messages.

In one embodiment, the wireless service provider 105 may provide a high-data rate and a quality of service (QoS) level on the digital wireless network 120 to enable a wireless access concurrently to at least two multi-media data applications. By integrating access to the location-based service(s) 110 with the multi-media services 115, the wireless service engine 145 may enable substantially simultaneous access to a first application (APP) 165(1) that provides the location-based service(s) 110 and a second application that provides the multi-media service(s) 115 for voice and data.

To provide the wireless connectivity to the tracking and target mobile terminals 125(1, 2) according to any desirable protocol, a plurality of base stations coupled to a radio network controller (RNC) (not shown) may be associated with the digital wireless network 120. Examples of such a protocol include a Code Division Multiple Access (CDMA, cdma2000) protocol, an Evolved Data Optimized (EVDO, 1×EVDO) protocol, a Universal Mobile Telecommunication System (UMTS) protocol, a Global System for Mobile communications (GSM) protocol, and the like.

Examples of the tracking and target mobile terminals 125(1, 2) may include a host of wireless communication devices including, but not limited to, cellular telephones, personal digital assistants (PDAs), and global positioning systems (GPS) that employ the high-speed wireless communication system 100 to operate in the digital wireless network 120, such as a cellular or mobile data network. Other examples of the tracking and target mobile terminals 125(1, 2) may include smart phones, text messaging devices, and the like. The tracking and target mobile terminals 125(1, 2) may encompass additional features and applications than typically available on a conventional cellular phone. Examples of different features and applications include e-mail service, Internet access, audio-video interfaces for music and media content streaming.

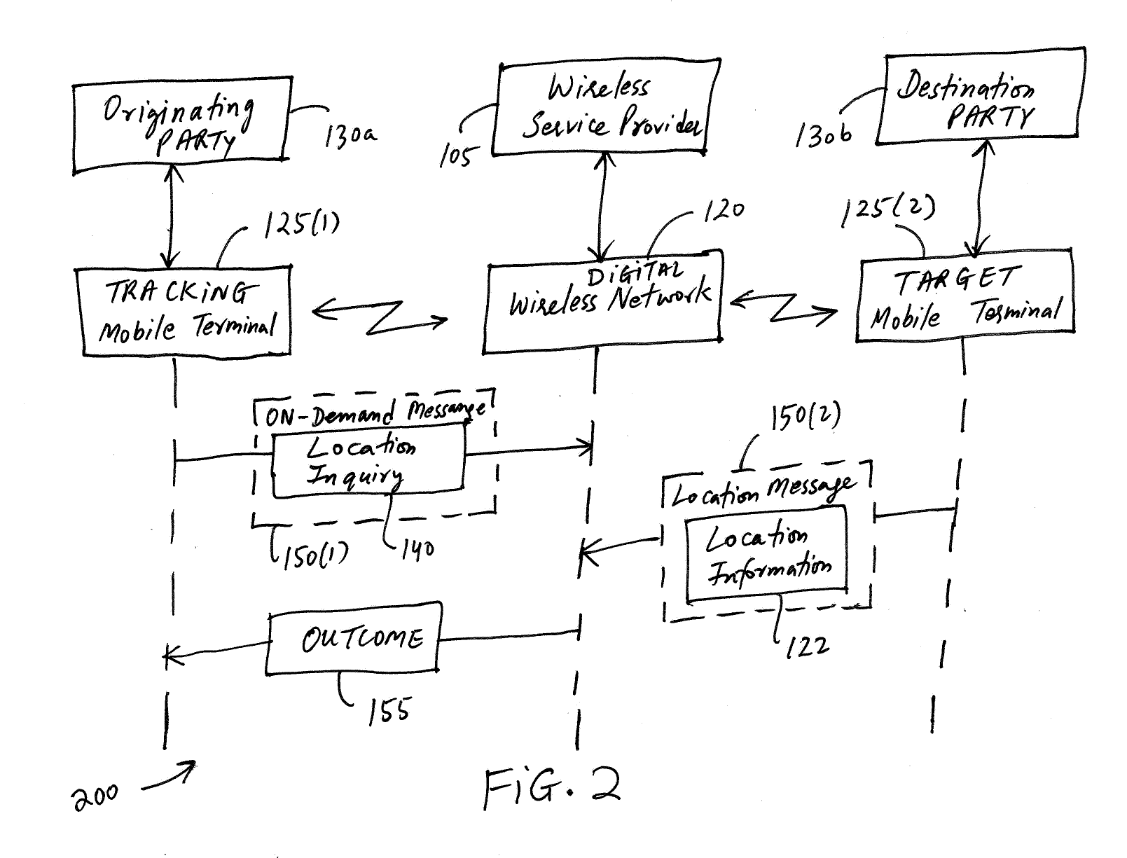

Referring to FIG. 2, a stylized representation of a service platform 200 that enables substantially simultaneously the location-based service(s) 110 and the multi-media service(s) 115 is depicted according to one illustrative embodiment of the present invention. By using the service platform 200, the wireless service provider 105 may offer at least one location-based service 110 substantially simultaneously with at least one multi-media service 115 for voice and data over the digital wireless network 120. For example, the service platform 200 may enable a packet-based data communication framework to additionally or optionally offer a set of digital wireless services associated with the location-based service 110.

The originating party 130a may send the location inquiry 140 for determining a remote location of a user of the target mobile terminal 125(2) available to the destination party 130b to initiate the location-based service 110 over the digital wireless network 120. To trigger the location-based service 110 on-demand for the destination party 130b, the originating party 130a may receive the outcome 155 for the location inquiry 140. The outcome 155 for the location inquiry 140 may indicate completion of the location inquiry 140. In response to receiving an indication for completion of the location inquiry 140, the originating party 130a may initiate a set of digital wireless services associated with the remote location and/or the destination party 130b.

The service platform 200 may authorize the tracking mobile terminal 125(1) associated with the originating party 130a to perform the location inquiry 140 on-demand over the digital wireless network 120. The service platform 200 may exchange messages between the digital wireless network 120 shown in FIG. 1 and the tracking mobile terminal 125(1), the target mobile terminal 125(2) of the destination party 130b in response to the location inquiry 140 initiated by the originating party 130a. For sending the location inquiry 140 to the wireless service provider 105, in one embodiment, the service platform 200 may exchange the on-demand message 150(1) between the tracking mobile terminal 125(1) and the digital wireless network 120. In response to the location inquiry 140 from the originating party 130a, the wireless service provider 105 may map the destination party 130b to the target mobile terminal 125(2) associated with the destination party 130b.

To process the location inquiry 140 for enabling the location-based service 110 at the originating party 130a, the service platform 200 may cause the wireless service provider 105 to interact with the target mobile terminal 125(2) over the digital wireless network 120. For example, for determining a remote location of the destination party 130b for the location-based service 110 the destination party 130b may receive an indication of the location inquiry 140 at the target mobile terminal 125(2). In response to the indication, the destination party 130b may provide the location information 122 of the target mobile terminal 125(2) to the originating party 130a over the digital wireless network 120. According to one embodiment, for providing the location information 122 to the tracking mobile terminal 125(1), the service platform 200 may exchange the location message 150(2) between the digital wireless network 120 and the target mobile terminal 125(2).

By indicating completion of the location inquiry 140, the wireless service provider 105 may cause the originating party 130a to initiate a set of digital wireless services associated with the network location of the target mobile terminal 125(2) and/or the destination party 130b. The service platform 200 may enable the originating party 130a to initiate an interactive message session with the designation party 130b at the target mobile terminal 125(2). Using the service platform 200, the originating party 130a may place a call to the destination party 130b while the target mobile terminal 125(2) may still be in use by the destination party 130b. The originating party 130a may request additional information associated with the network location of the target mobile terminal 125(2). After the location-based service(s) 100 may be triggered, each party may use location of another destination party and subsequently engage more subscribers into the communication.

In this way, the service platform 200 may stimulate usage of the digital wireless network 120 beyond typical mobile data. In the service platform 200, the location-based service(s) 110 and the multi-media service(s) may be triggered by the location inquiry 140 for the destination party 130b. That is, the destination party 130b may be mapped to a specific mobile terminal that have subscribed to the digital wireless network 120. The location inquiry 140 may be performed on-demand by the originating party 130a authorized for sending an inquiry, which is conducted by the digital wireless network 120 and the target mobile terminal 125(2) with no active participation from the destination party 130b. Once the location inquiry 140 is complete, the originating party 130a may initiate other services associated with the remote location or the destination party 130b. For example, services regarding a map of neighborhood, point of attractions around the location may be initiated.

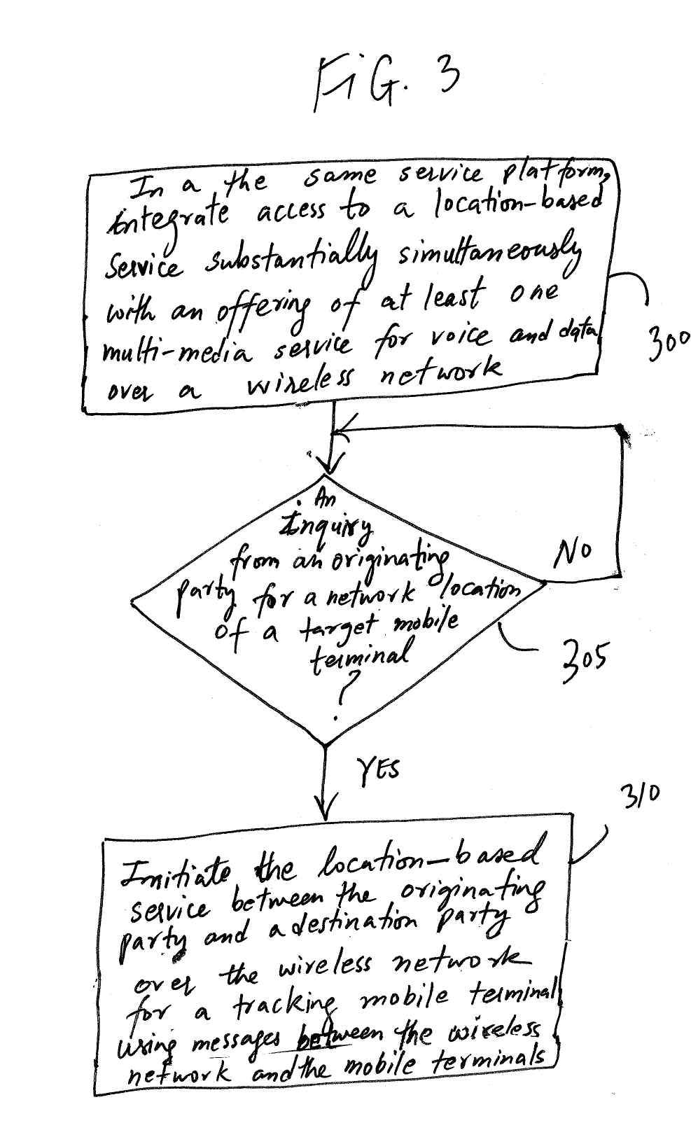

Turning to FIG. 3, consistent with one exemplary embodiment of the present invention, a stylized representation for implementing a method of enabling the location-based service(s) 110 between the originating party 130a and the destination party 130b shown in FIG. 1 is depicted. In the same service platform 200 shown in FIG. 2, access to at least one location-based service 110 may be integrated substantially simultaneously with an offering of at least one multi-media service 115 for voice and data over the digital wireless network 120, as indicated in block 300.

A decision block 305 may indicate whether the originating party 130a initiated the location inquiry 140 to the wireless service provider 105 over the digital wireless network 120. In response to receiving the location inquiry 140 from the originating party 130a, at block 310, the wireless service provider 105 may initiate the location-based service 110 for determining a network location of the target mobile terminal 125(2) associated with the destination party 130b. The service platform 200 may exchange messages between the digital wireless network 120 and the target mobile terminal 125(2), tracking mobile terminal 125(1)

Accordingly, the service platform 200 may provide a service framework for a mobile data network environment in high-speed wireless mobile data access systems. In such a fully integrated service generation platform triggered by on-demand location inquiries, the location-based services(s) 110 and the multi-media service(s) 115 may be simultaneously provided, especially to families with children. For example, a service may provide a convenient way for the parents to track the whereabouts of their children when they desire and may flexibly contact in a variety ways under different circumstances, while the children may still utilize the mobile terminals for normal communication purposes. Similar applications may be enabled between other family members and friends.

Consistent with one embodiment, the originating party 130a may determine self location and initiate services based on an inquiry outcome. Various features of the service platform 200 may be enabled in conventional mobile terminals. Since the location inquiry 140 may occur on demand, a persistent burden to track a user's location for offering the location-based service(s) 110 may be obviated. Accordingly, use of the service platform 200 in the digital wireless network 120, such as a mobile data network may significantly boost the mobile data network traffic usage.

In one embodiment, by using of the service platform 200, a high-speed wireless data network may wirelessly communicate mobile data at a speed and coverage desired by individual users or enterprises. According to one embodiment, the high-speed wireless data network may comprise one or more data networks, such as Internet Protocol (IP) network comprising the Internet and a public telephone system (PSTN). The 3rd generation (3G) mobile communication system, namely Universal Mobile Telecommunication System (UMTS) supports multimedia services according to 3rd Generation Partnership Project (3GPP) specifications. The UMTS also referred as Wideband Code Division Multiple Access (WCDMA) includes Core Networks (CN) that are packet switched networks, e.g., IP-based networks. Because of the merging of Internet and mobile applications, the UMTS users can access both telecommunications and Internet resources. To provide an end-to-end service to users, a UMTS network may deploy a UMTS bearer service layered architecture specified by Third Generation Project Partnership (3GPP) standard. The provision of the end-to-end service is conveyed over several networks and realized by the interaction of the protocol layers.

Portions of the present invention and corresponding detailed description are presented in terms of software, or algorithms and symbolic representations of operations on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, or as is apparent from the discussion, terms such as “processing” or “computing” or “calculating” or “determining” or “displaying” or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

Note also that the software implemented aspects of the invention are typically encoded on some form of program storage medium or implemented over some type of transmission medium. The program storage medium may be magnetic (e.g., a floppy disk or a hard drive) or optical (e.g., a compact disk read only memory, or “CD ROM”), and may be read only or random access. Similarly, the transmission medium may be twisted wire pairs, coaxial cable, optical fiber, or some other suitable transmission medium known to the art. The invention is not limited by these aspects of any given implementation.

The present invention set forth above is described with reference to the attached figures. Various structures, systems and devices are schematically depicted in the drawings for purposes of explanation only and so as to not obscure the present invention with details that are well known to those skilled in the art. Nevertheless, the attached drawings are included to describe and explain illustrative examples of the present invention. The words and phrases used herein should be understood and interpreted to have a meaning consistent with the understanding of those words and phrases by those skilled in the relevant art. No special definition of a term or phrase, i.e., a definition that is different from the ordinary and customary meaning as understood by those skilled in the art, is intended to be implied by consistent usage of the term or phrase herein. To the extent that a term or phrase is intended to have a special meaning, i.e., a meaning other than that understood by skilled artisans, such a special definition will be expressly set forth in the specification in a definitional manner that directly and unequivocally provides the special definition for the term or phrase.

While the invention has been illustrated herein as being useful in a telecommunications network environment, it also has application in other connected environments. For example, two or more of the devices described above may be coupled together via device-to-device connections, such as by hard cabling, radio frequency signals (e.g., 802.11(a), 802.11(b), 802.11(g), Bluetooth, or the like), infrared coupling, telephone lines and modems, or the like. The present invention may have application in any environment where two or more users are interconnected and capable of communicating with one another.

Those skilled in the art will appreciate that the various system layers, routines, or modules illustrated in the various embodiments herein may be executable control units. The control units may include a microprocessor, a microcontroller, a digital signal processor, a processor card (including one or more microprocessors or controllers), or other control or computing devices as well as executable instructions contained within one or more storage devices. The storage devices may include one or more machine-readable storage media for storing data and instructions. The storage media may include different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy, removable disks; other magnetic media including tape; and optical media such as compact disks (CDs) or digital video disks (DVDs). Instructions that make up the various software layers, routines, or modules in the various systems may be stored in respective storage devices. The instructions, when executed by a respective control unit, causes the corresponding system to perform programmed acts.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

What is claimed:

1. A method of enabling at least one location-based service between an originating party and a destination party on a wireless network, the method comprising:
integrating access to said at least one location-based service substantially simultaneously with an offering of at least one multi-media service for voice and data over said wireless network; and
initiating said at least one location-based service in response to receiving an inquiry from said originating party for determining a network location of a target mobile terminal associated with said destination party.

2. A method, as set forth in claim 1, wherein initiating said at least one location-based service further comprises:
using a first message exchange between said wireless network and a tracking mobile terminal for said originating party and a second message exchange between said wireless network and said target mobile terminal for said destination party to provide said at least one location-based service.

3. A method, as set forth in claim 1, wherein initiating said at least one location-based service further comprises:
generating an outcome for said inquiry to trigger said at least one location-based service on-demand by said originating party.

4. A method, as set forth in claim 1, wherein integrating access to said at least one location-based service further comprises:
enabling substantially simultaneous access to a first application that provides said at least one location-based service and a second application that provides said at least one multi-media service for voice and data.

5. A method, as set forth in claim 1, further comprising:
enabling integrated data access to a set of digital wireless services associated with said at least one location-based service for a subscriber over said wireless network.

6. A method, as set forth in claim 1, further comprising:
determining a remote location of a user based on said network location of said target mobile terminal available to said destination party on said wireless network.

7. A method, as set forth in claim 6, further comprising:
using an indication of user mobility of said user over said wireless network and a capability to retrieve location information of said target mobile terminal to offer said at least one location-based service.

8. A method, as set forth in claim 6, further comprising:
providing a high-data rate and a quality of service level on said wireless network to enable a wireless access concurrently to at least two multi-media data applications.

9. A method, as set forth in claim 1, further comprising:
enabling a service platform for a wireless service provider to offer said at least one location-based service substantially simultaneously with said at least one multi-media service for voice and data over said wireless network.

10. A method, as set forth in claim 9, further comprising:
offering a set of digital wireless services associated with said at least one location-based service in a packet-based data communication framework.

11. A method, as set forth in claim 9, further comprising:
indicating when said inquiry is complete; and
causing said originating party to initiate said set of digital wireless services associated with at least one of said network location of said target mobile terminal and said destination party.

12. A method, as set forth in claim 9, further comprising:
in response to said inquiry from said originating party, mapping said destination party to said target mobile terminal of said destination party.

13. A method, as set forth in claim 12, further comprising:
causing said wireless service provider to interact with said target mobile terminal over said wireless network to conduct said inquiry.

14. A method, as set forth in claim 12, further comprising:
authorizing said tracking mobile terminal associated with said originating party to perform said inquiry on-demand over said wireless network.

15. A method, as set forth in claim 12, further comprising:
enabling said originating party to at least one of request additional information associated with said network location of said target mobile terminal of said destination party, to place a call to said destination party while said target mobile terminal is still in use and to initiate an interactive message session with said designation party at said target mobile terminal.

16. A method of enabling at least one location-based service between an originating party and a destination party on a wireless network, the method comprising:
receiving an indication of an inquiry at a target mobile terminal for determining a remote location of said destination party for said at least one location-based service; and
in response to said indication, providing location information of said target mobile terminal to said originating party over said wireless network.

17. A method, as set forth in claim 16, wherein providing location information of said target mobile terminal further comprises:
exchanging a message between said wireless network and said target mobile terminal for providing said location information to said wireless network to enable said at least one location-based service for said originating party.

18. A method of enabling at least one location-based service between an originating party and a destination party on a wireless network, the method comprising:
sending an inquiry for a remote location of a user of a target mobile terminal available to said destination party to initiate said at least one location-based service for said destination party over said wireless network.

19. A method, as set forth in claim 18, further comprising:
in response to receiving an indication for completion of said inquiry, initiating a set of digital wireless services associated with at least one of said remote location and said destination party.

20. A method, as set forth in claim 18, further comprising:
receiving an outcome for said inquiry to trigger said at least one location-based service on-demand for said destination party.
